(19) United States
(12) Patent Application Publication
(10) Pub. No.: US 2016/0300477 A1
(43) Pub. Date: Oct. 13, 2016

(54) WIRELESS ALARM SYSTEM

(71) Applicant: Elarm Inc., Seattle, WA (US)

(72) Inventors: Daniel J. Pickford, Seattle, WA (US); Adam D. Rea, Seattle, WA (US)

(21) Appl. No.: 15/092,309

(22) Filed: Apr. 6, 2016

Related U.S. Application Data
(60) Provisional application No. 62/146,122, filed on Apr. 10, 2015.

(51) Int. Cl. G08B 25/10

(52) U.S. Cl. CPC G08B 25/10

(57) ABSTRACT

A security system comprising a plurality of sensors is disclosed. The plurality of sensors may be of at least two different sensor types and a set of rules that are each different from one another may specify at least one action to take based on a reported sensor condition for a respective set of sensors. The at least one of the sets of sensors may include at least two of the sensors. Further, the set of rules are applied to the received sensor conditions received from the sensors and an action specified by a respective one of the rules is taken based on the received sensor conditions.

### BACKGROUND

1. Technical Field

The present disclosure relates generally to a wireless alarm system.

2. Description of the Related Art

Conventional alarm systems employ wired-based communication between sensors and a central unit responsible for alarming when a sensor is triggered. When an alarm system is activated, triggering any sensor will cause an alarm to be initiated.

### BRIEF SUMMARY

Conventional alarm systems are not intelligently adaptable to user requirements. Furthermore, conventional alarm systems do not permit customization of alarm triggers based at least in part on user input.

Accordingly, it is desirable to have an alarm system that enables customization of alarm triggers based on the environmental reading of a plurality of sensors.

A security system may be summarized as including: a plurality of sensors of each of at least two different sensor types; a controller communicatively coupled to the sensors, the controller having at least one processor and at least one nontransitory processor-readable medium communicatively coupled to the controller and which stores at least one of processor executable instructions or data which, when executed by the at least one processor, cause the controller to: store a set of rules to the at least one nontransitory processor-readable medium, the rules which include at least three rules, the rules different from one another, each of the rules which specify at least one action to take based on a reported sensor condition for a respective set of sensors, at least one of the sets of sensors including at least two of the sensors; apply the set of rules to the received sensor conditions received from the sensors; and taking the action specified by a respective one of the rules based on the received sensor conditions.

The at least one processor may autonomously specify at least one of the rules based on a history of received sensor conditions. The at least one processor may execute a machine learning algorithm to autonomously specify the at least one of the rules based on the history of received sensor conditions and a history of corresponding user input. The at least one processor may execute a machine learning algorithm to autonomously specify at least one of new sets of sensors or new rules. The at least one processor may prompt a user to accept or reject the new sets of sensors or new rules. The at least one processor may receive user input that specifies at least one of the rules of the set of rules. The at least one processor may receive user input that specifies at least one of the sets of sensors. The at least one processor may receive user input that specifies at least one set of sensor conditions for the sensors of the sets of sensors. The at least one processor may receive user input that specifies at least one action to take as part of one of the rules. At least one of the sets of sensors may be specified based on a proximity of the sensors with respect to one another. At least one of the sets of sensors may be specified based on a sensor type of the sensors. At least one of the sets of sensors may be specified based on a room within which the sensors are located.

A security system may be summarized as including: a monitoring service that wirelessly communicates with a plurality of sensor nodes, the monitoring service: receives an indication of a detected environmental condition from a sensor node of the plurality of sensor nodes; receives data specifying a grouping of a set of sensor nodes of the plurality of sensor nodes and logically groups the set of sensor nodes in response to receiving the data; receives data specifying one or more conditions for triggering an alarm based on a corresponding set of environmental conditions detected by the set of sensor nodes; detects that the one or more conditions for triggering the alarm are met; and sends a message indicating that the one or more conditions for triggering the alarm are met.

The security system may further include: the plurality of sensor nodes, the sensor node of the plurality of sensor nodes detects the environmental condition in an associated proximity of the sensor node and wirelessly transmits the indication of the detected environmental condition. The data specifying the grouping of the set of sensor nodes and the data specifying the one or more conditions for triggering the alarm may be user-specified.

A method for providing an alarm may be summarized as including: receiving, from a sensor of a plurality of sensors, corresponding data indicating an environmental reading of a detected environmental condition in a proximity of the sensor; receiving one or more criteria for triggering an alarm based on the data corresponding to the plurality of sensors, the one or more criteria for triggering the alarm are satisfied if a first condition placed on a first environmental reading associated with a first sensor of the plurality of sensors is met within a specified time period of a second condition placed on a second environmental reading associated with a second sensor of the plurality of sensors being met; evaluating the received data corresponding to the plurality of sensors; and providing the alarm if the one or more criteria for triggering the alarm are satisfied.

Providing the alarm may include sending a message to an address associated with a user of an alarm system.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram showing an environment in which a monitoring service is communicatively coupled to a plurality of security systems.

FIG. 2 is a top plan view of premises with a security system, the security system including a base station node and one or more sensing nodes communicatively coupled to the base station node.

FIG. 3 is a schematic diagram of the security system of FIG. 2 having two overlaid wireless networks in accordance with at least one illustrated embodiment.

FIG. 4 is a schematic diagram of a security system having a partial high bandwidth link failure and recovery.

FIG. 5 is a schematic diagram of a security system having low bandwidth link failures and recovery.

FIG. 6 is a schematic diagram of a security system which includes a plurality of nodes forming a connection to a coordinator node.

FIG. 7 is a top plan view of a residence with a security system which includes sensors grouped based on sensor type.

FIG. 8 is a top plan view of a residence with a security system which includes sensors grouped autonomously by the security system.

FIG. 9 is a top plan view of a residence with a security system which includes sensors grouped in user-defined grouping based on location.

FIG. 10 is a top plan view of a residence with a security system which includes sensors grouped based on node attributes.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

It is important for networks to be highly available in certain domains, such as the security domain, where data is monitored for spurious anomalies and the monitored data is used for making various decisions. Further, sending nodes may not be solely designed to communicate data. Instead, design considerations including power usage, size, cost and data density are also taken into account. In lightweight nodes or small data nodes, such as environmental sensing nodes, power and size are the most important design considerations as the data offload is low enough in density permitting the use of a lower bandwidth (or lower power) commodity communication protocol, such as IEEE 802.15.4, BlueTooth, BlueTooth Low Energy (BLE), proprietary communication protocols, Infrared Data Association (IrDA) and the like. In heavier-weight nodes or big data nodes, such as video collection or audio analysis nodes, the data density warrants a communication subsystem that offers more bandwidth for data transport. A communication protocol, such as Institute for Electrical and Electronics Engineers (IEEE) 802.3, IEEE 802.11, 60 GHz, and the like, may be used. The use of two or more asymmetric networks is driven by the systemic requirements of the overall system. The overhead of maintaining multiple network topologies has traditionally been seen as a detractor for system setup and maintenance, but it affords some benefits when leveraged for data redundancy and control.

Additionally, security systems have traditionally been hardwired for connectivity. As such, their installation requires professional installers and is particularly undesirable in a “finished” construction home or business. With the advances in wireless connectivity reliability and with the advent and standardization of a spectrum of commodity wireless connectivity protocols (such as IEEE 802.15.4, BlueTooth, BLE, IEEE 802.11, Low power IEEE 802.11 (colloquially known as low power WiFi), 802.11, IrDA and the like), a move to user installable sensing nodes for a security system is now possible. The inclusion of a wireless link, while important, speaks nothing to the underlying problems with historical security systems. In the past, these systems have possessed little to no ability to discriminate false positive signals from true alarm events. By combining a variety of wirelessly-connected sensors with a statistical reasoning engine, it is possible to create an alarm system that is both easy to install and maintain (due to the use of wireless communications) while increasing the accuracy of the resulting alarm signals (enabled by the use sensor fusion and statistical reasoning techniques). While both techniques may be implemented independently, a system incorporating wireless communications and a sensor fusion and statistical reasoning engine is advantageous as a result of its accuracy and reliability. These advantages may not be found in systems that utilize wireless communications but not a sensor fusion and statistical reasoning engine, or vice-versa. As described herein, sensor fusion may include processing collective data received from a plurality of sensors and/or utilizing the processed data to determine whether conditions for alarm are met. Furthermore, sensor fusion may include grouping a plurality of sensors in a logical group and utilizing the sensor readings of the plurality of sensors to determine whether to trigger an alarm.

A grouping or classification overlay may be used in conjunction with sensor data to make alarm systems effective, flexible and accurate. For example, one or more autonomous (or system-defined) criteria or explicit (or user-defined) criteria may be imposed. The groupings may be based on the type of nodes or the location of the nodes. Further, the groupings may be defined so as to serve another functional end. The groupings, whether autonomously or explicitly generated, may be used by a reasoning engine to improve results or target specific activities or behaviors. In addition to the groupings, a user of the system may define rules. The rules may specify a pattern (for example, temporal or spatial) of triggering of an individual sensor or a small group of sensors. If the pattern is detected, a particular (for example, user-defined) message may be sent to a user or another party, such as a security or emergency response center. An interface that allows for pattern definition based on conditional rules may be used (for example, by a user of the system) to establish behavior detection alerts to either a security or informative end.

Multiple networks may provide a higher total network availability for delivering voluminous and timely data to a security engine. Further, high bandwidth agents may act as a backup route for traffic on a compromised low bandwidth channel. Similarly, the low bandwidth channel may be used for control, repair and emergency messaging if the high bandwidth channel is compromised.

The combination of wirelessly-connected heterogeneous sensing nodes combined with sensor fusion and statistical reasoning techniques on the resulting data leads to an efficient, robust and accurate security system. By leveraging the wireless capabilities of the sensing nodes, a consumer-installable system that has more placement freedom and is inherently more scalable than a wired counterpart may be implemented. Additionally, the inclusion of the sensor fusion and statistical reasoning engine leverages increased sensor data to determine more accurately the magnitude and severity of a security breach, thus rendering a highly reliable, non-intrusive, and complete security system.

Providing both the system and the user with the capability to group, categorize and establish viable patterns and rules within the system facilitates both the ease of use of the system as well as the overall effectiveness of the system. To this end, two modalities of rule creation may be made available. The first is directed at enabling the system to autonomously generate its own groupings of sensors and associated or corresponding pattern rules. Statistical reasoning techniques may be used to enable autonomous system-generated rules. Secondly, groupings of sensors and associated or corresponding rules may be generated based on explicit user interaction and insight. While the focus of the first approach is the application with advanced modeling techniques, the second relies on providing a system for defining both the groupings of sensors and associated or corresponding rules that is intuitive to use while still being a powerful agent. Thus, the system may be logically complete while providing a user interface to leverage its capability.

The security systems described herein are advantageous in that the benefit of having multiple communication channels is leveraged and the communication channels are used in concert. Monitoring of all communication links as well as the use of “super nodes” (i.e., nodes having more than one communication offload path) makes it possible to create resilient network links and adds redundancy to the overall system while offering multiple control planes and communication paths for the system as a whole.

Another difference is the use of wireless sensing nodes as opposed to wired nodes. Wireless sensing nodes are easily deployed around a home, business, or other premises without the need of running communication wires to a central location. This has several effects on the efficacy of the system. It makes the system more easily scalable; one can place a new node (or type of node) where needed without the effort or expense of running hard wires. Further, the system is transportable as it can be uninstalled from one location and re-installed in a new location inexpensively. Another advantage to current wired approaches is the absence of a central “punch down” closet for the security system, which makes it more difficult for a nefarious actor to attack the system from a central or common location.

As to the sensor fusion and statistical reasoning techniques, current security systems have relatively high false positive rates. Some studies have shown that over 97% of alarms generated by home security systems are false positives. This stems from the fact that any individual alarm condition generated (glass break or open door and the like), irrespective of its relative importance, results in the whole system triggering an alarm. The individual nodes are comprised of various types of sensors that can measure different attributes in the environment in which they are placed. The system uses the data from these sensors together with sensor fusion and statistical reasoning techniques to correlate system-wide data and ascribe a threat value to an entirety of a dataset and not just an individual data point or anomaly. The result is that the security system is more robust and able to suppress spurious events that do not correlate with the readings associated with other sensors. This has the effect of drastically reducing the false positive rates for alarms while, at the same time, raising the confidence level of the true positive alarm events.

As described herein, both the system and/or the user can specify or define groups of sensors nodes and rules that govern alerts. Traditional systems rely on either all system-defined rules or user-defined rules. However, it is advantageous to have both modalities available. For example, the system-generated rules may state that if a sensor detects door movement, an alarm is not triggered unless another movement is detected by a nearby sensor. This may be a practical rule for detecting intrusion, but it is only available if the alarm system is enabled. Conversely, a user may put a door sensor on a gun safe door. The user may set a rule to provide notification if this sensor ever detects motion even if the system is not actively monitoring for intrusion or if no other sensors are activated.

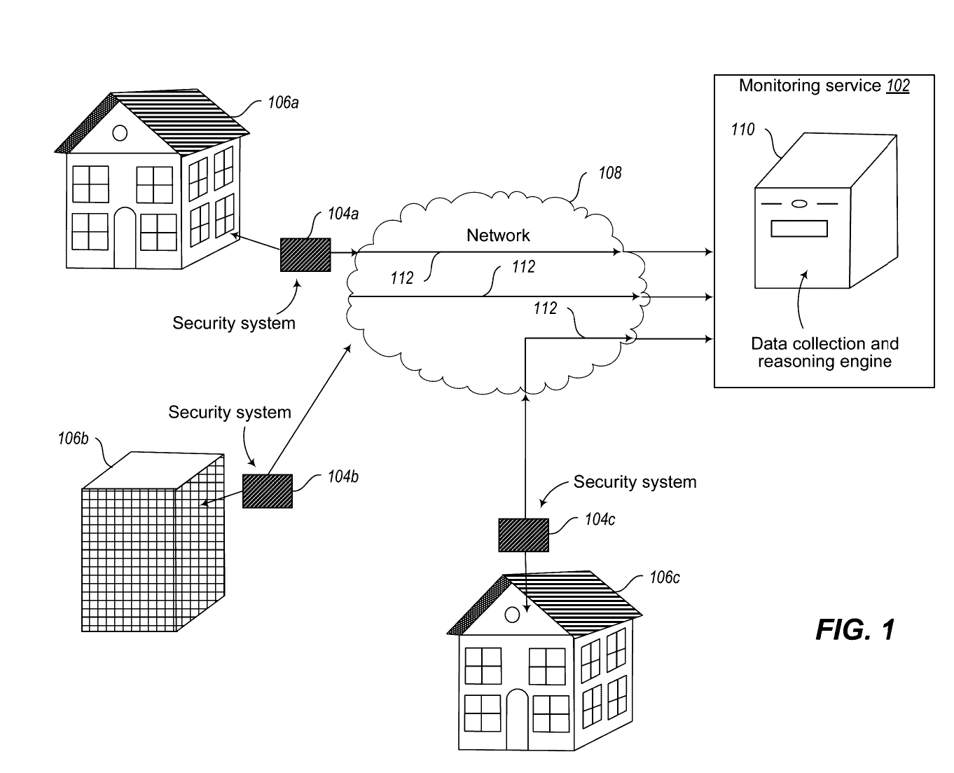

FIG. 1 shows of a monitoring service 102 connected to a plurality of security systems 104a, 104b, 104c. The plurality of security systems 104a, 104b, 104c (collectively 104), may each be associated with a corresponding protected structure 106a, 106b, 106c (collectively 106), such as a building including an office or a residence. A security system 104 may communicate with the monitoring service 102 over a network 108, which may be any type of network, such as a wide-area network.

The security system 104 may send preprocessed data 112 to the monitoring service 102. The security system 104 may have limited computational or data processing capability available relative to that of the monitoring service 102, which may be associated with one or more data processing units. The use of the monitoring service 102 and the computational capability thereof is advantageous in that it ensures that the computational requirements of the individual security systems 104 do not effectively limit the computational power of the overall system. An individual security system 104 may send partially processed, or raw, data back to a centralized data collection and processing core for higher fidelity results than possible locally. Further, another key advantage of this processing hierarchy is that data 112 from individual security systems may be coordinated and correlated to determine larger area problems and intrusions. In addition, it may also be used to help establish trends that are localized to neighboring security systems 104 connected to the same common remote processing core. That can serve to alert other individual security systems 104 that a problem is expected and make the system more sensitive to attack.

Another advantage of the centralized connectivity is that the rules for detection may be refined over time by the centralized core based on the aggregated data of all the individual systems connected to it and then communicated back downstream to improve the accuracy of the individual system's predictions and alerts.

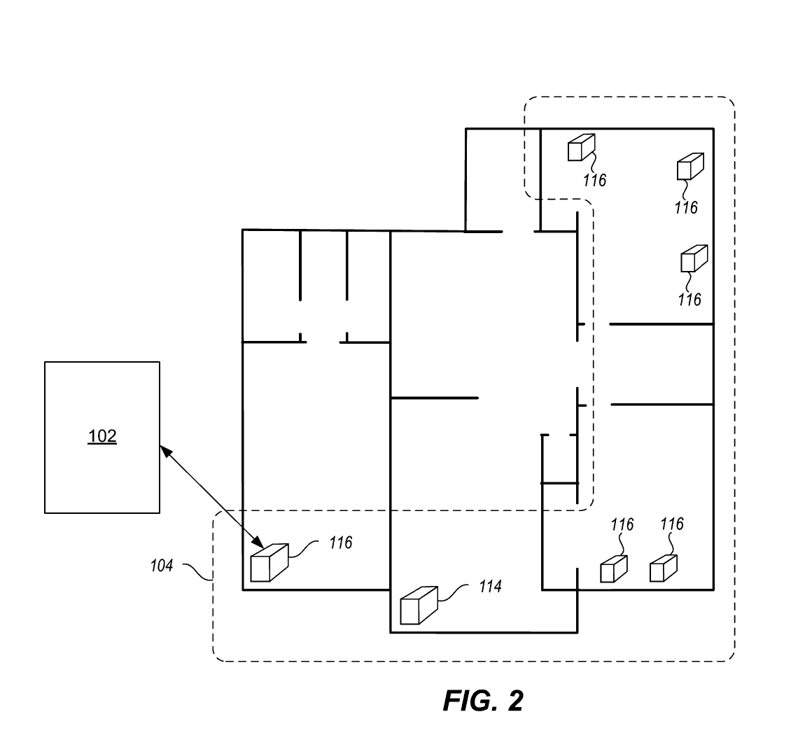

As illustrated in FIG. 2, a security system 104 may comprise a base station node 114 and one or more sensing nodes 116 communicatively coupled to the base station node. The base station 114 may include a central processing unit (CPU) that is connected to both the sensing nodes within the security system as well as a remote central processing core (for example, of the monitoring service 102). The base station node 114 receives the data from the sensing nodes and processes the data. The base station may have local computational capability and may service all data using the capability. Data requiring more computationally-intensive operations than that for which the base station is rated may be sent to a remote central processing core for analysis.

The base station may have bi-directional communication links (e.g., via transceivers and antennas) with sensing nodes. This allows for both a control channel for the local system as well as the ability to send pertinent data back to the sensing nodes themselves. The sensing nodes may be a collection of heterogeneous types of sensor collections. The commonality between all of these different types of nodes is that they possess a communication channel back to the base station and they can provide data about the environment in which they are placed. The communication channel is determined by the needs of the sensor for both data density and power consumption with higher bandwidth radios used for higher density data collectors and low power or low bandwidth radios used for low data density, battery borne data collectors. The base station acts as coordinator for these attached data collection nodes.

In a local system, the integrity of transported data is paramount. For example, data that is not received by the security system 104 may be as important to security system decision making as received data. Not only does the system need to receive the data collected in the network of devices for rendering informed decisions, but it must also be aware of the status of network nodes. For example, if a node is “offline” and is nonresponsive or non-communicative, that may be indicative of a possible attack on the system. Further, it is important for the attack to be detected, notated and communicated to the coordinator node so that the systemic impact can be fully considered.

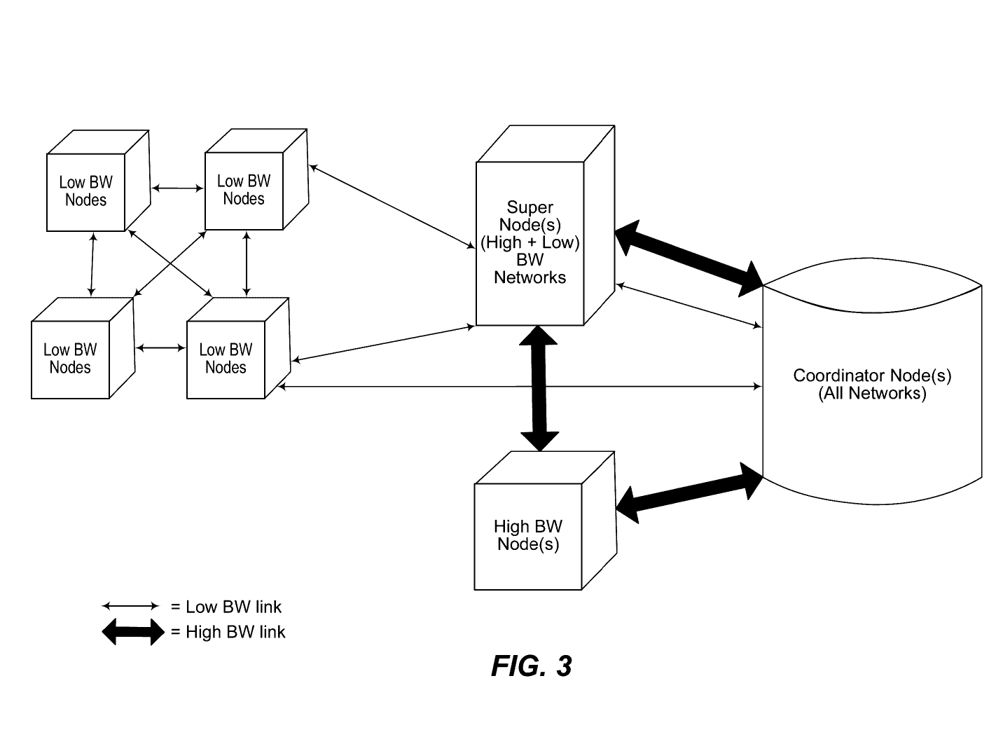

FIG. 3 is an illustration of a security system having two overlaid wireless networks in accordance with at least one illustrated embodiment. Several paths for redundancy and control are established in the topology of the security system of FIG. 3. Nodes that are deemed “super nodes” possess at least two network interfaces and can act as bridges and routers between two networks. The “coordinator node(s)” (sometimes known or referred to as the base station, root node or central node) act as both the destination for information gathered in the network and also as a primary node in setting up the overlays. That is because a coordinator node, generally, has access to all the network interfaces available to the system. The other nodes in the system have access to only one of the network topologies (for example, either high bandwidth or low bandwidth). Another benefit to having multiple networks available is that a network of the multiple networks may be used as an out-of-band mechanism for setting up or maintaining any of the other network interfaces as well as providing an out-of-band messaging mechanism to individual nodes. As described herein, overlays are advantageous when link failures occur.

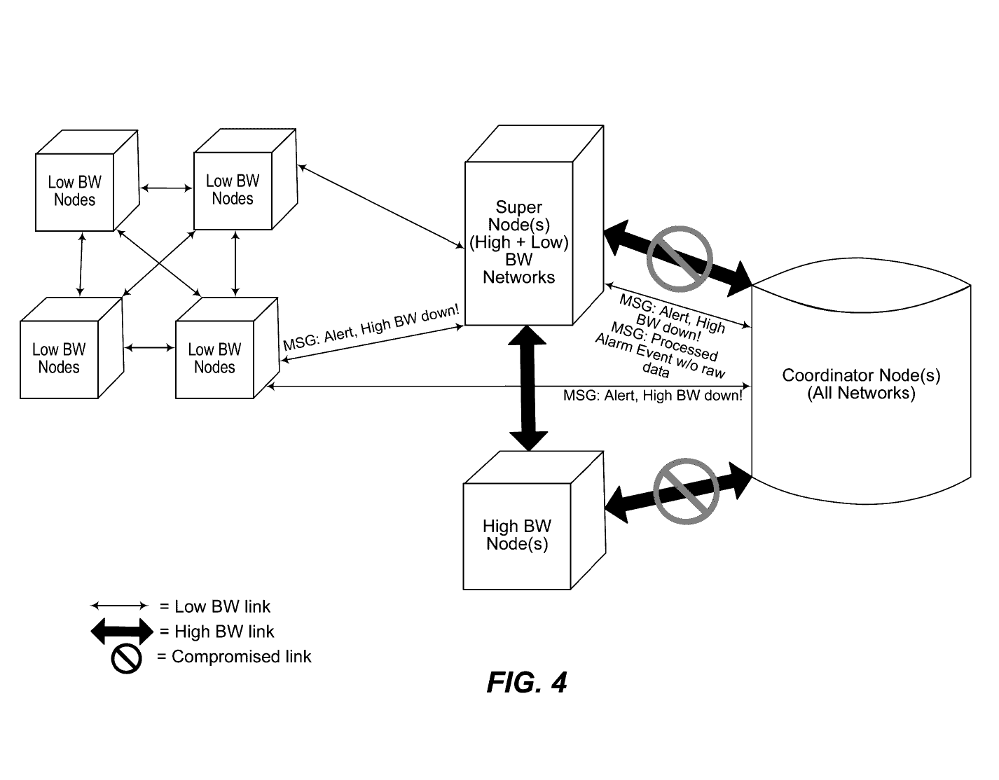

FIG. 4 illustrates the security system having a partial high bandwidth link failure and recovery. As shown in FIG. 4, the central node has lost connectivity to its high bandwidth neighbors. The low bandwidth network may be leveraged to deliver a message back to the central node that connectivity is lost. Accordingly, the low bandwidth network may be used as an out-of-band or backplane mechanism to restore the high bandwidth network. Additionally, the super node and the high bandwidth node may reduce the bandwidth of their messages to get information across the low bandwidth link to continue normal operation. For example, computed results may be sent in lieu of raw data such that the information delivered to the central node is as robust and reliable as it can be with the bandwidth limitation in place. The high bandwidth nodes may store data to be forwarded once the high bandwidth network is restored, or shunt the data if the raw data is not necessary to continue normal operation.

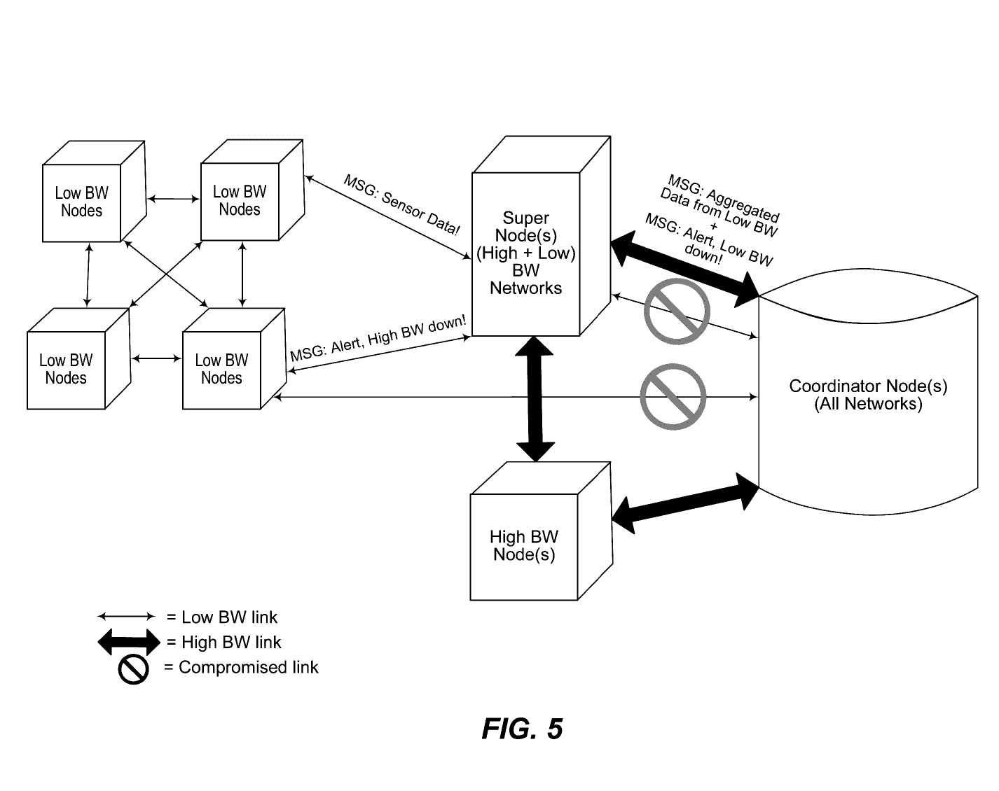

FIG. 5 illustrates the security system having low bandwidth link failures and recovery. Failure of the low bandwidth network may be overcome and restored using the high bandwidth network as a temporary route and restorative channel. As shown in FIG. 5, the central node has lost low bandwidth connectivity to some of the low bandwidth nodes. The super node may act as an aggregator of data for the low bandwidth nodes still connected and transmit this aggregated data back to the central node via its available high bandwidth link. Further, the super node may send a message to the central node indicating that there are problems with connectivity between some of the low bandwidth nodes. The central node may then attempt to repair the low bandwidth network while still having a communication path via the super node to aid in this repair.

It is noted that although the examples given here were for a low bandwidth and high bandwidth overlay, there is no fundamental limit on the number of networks that can be overlaid, nor is there a particular bias for any one technology. Wireless networks are generally more volatile than their wired counterparts (and thus more interesting for this application), but the approach works equally as well for all network overlays regardless of the physical transport medium. Also, while the delineation in the examples was bandwidth, the core of the concept is based around asymmetric networks overlaid on each other. The primary asymmetry discussed was bandwidth, but this approach works equally as well for networks which have asymmetries in any network dimension including power consumption, latency, or bandwidth, among others.

Looking at a heterogeneous collection of wireless sensor nodes, we can see the connections that are formed back to the coordinator node (FIG. 4). It is important to note that the coordinator node must be able to communicate with all the disparate sensor nodes, but it is not necessary that all of the sensor nodes use the same wireless spectrum or protocol. It is the responsibility of the coordinator node to support all of the wireless communication protocols, either independently or with the assistance of aggregator nodes that can receive on wireless communication protocol and retransmit it using a wireless technology that the coordinator node can receive.

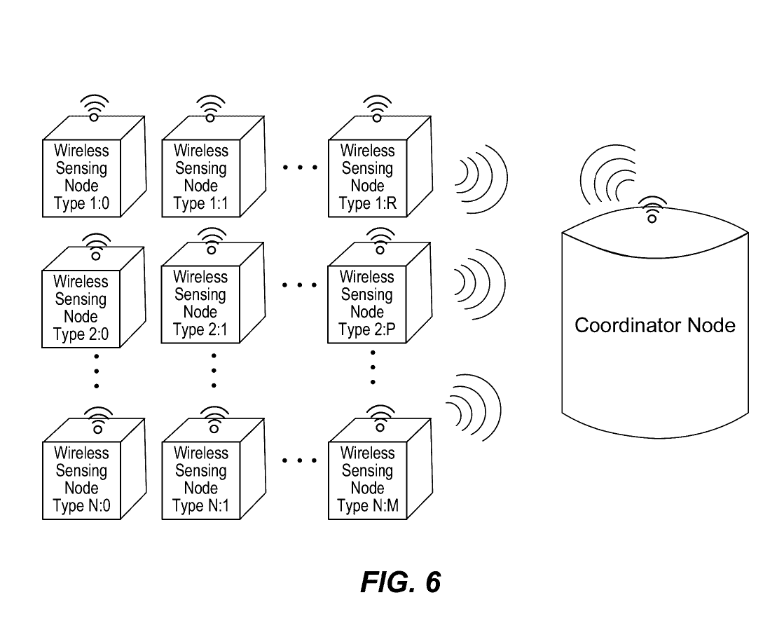

FIG. 6 illustrates a plurality of nodes forming a connection to a coordinator node. The sensor nodes may be a mesh network, ad hoc connections or an infrastructure-dependent set of communicators, among others. Furthermore, the techniques described herein may be agnostic to the type of connection and not reliant on a wired infrastructure to enable communication between the nodes. The use of a wireless infrastructure results in an ease of installation and reduction in the materials and infrastructure necessary to connect the network. Further, the network may be self-forming.

After the network is formed and the sensor nodes are capable of relaying data, the coordinator node may collect messages and use them in a statistical engine. The data supplied may be raw sensor data, processed sensor data, virtual sensor data (sometimes referred to as “soft-sensing”) or meta-sensor data (data that is created by mixing any combination of raw, processed, virtual and metadata to form a data type). This data stream is provided to a statistical processing engine. Once the disparate nodes' sensor data has been aggregated by the central node, a number of processing steps may be performed to generate results.

The data is provided to a feature extractor, which extracts the characteristics of the data that are used by a downstream system. Feature extraction may be specific to the type of data being operated upon and is unique to each sensor type. For example, if audio data was being processed, a fast Fourier transform (FFT) is used to extract frequency domain information. The frequency domain information may reveal the frequency components and their intensities in the waveform, overall amplitude of the waveform and the total energy density of the waveform. The frequency domain information may all be used by the classification engine and, accordingly, should be extracted beforehand. It is important to note that different extracted features from the same raw data may be useful for different classification results; the features extracted are directly dependent on the desired classification results. After the feature extraction, some or all of the features may be processed through a feature boosting algorithm. The purpose of feature boosting is to increase the accuracy results in the final classification. The boosting amplifies the extracted features output by increasing the reliability of the feature with respect to the classification results. Boosting algorithms, like the feature extractors, are designed for specific data input.

The extracted and boosted data features are then run into the classification engine. This engine utilizes Bayesian networks in the form of hidden Markov models (HMMs) and hierarchical HMMs to produce a statistical probability of the likelihood that the data indicates each of the possible classifier outcomes. The classification engine may output the probability for each of the possible outcomes of the classifier. This matrix of probabilities is then used to determine what the raw data represents. If one classification result is much higher than other classification results, it may be indicative that the classification is a proper result. If the classification does not yield a distinguishable result, the inference may be deemed to be weaker and may be used to filter out false positives.

The use of HMMs and hierarchical HMMs offers two main advantages. HMMs and hierarchical HMMs allow for multiple data sources or streams to be correlated and simultaneously processed for system-wide analysis. In addition, HMMs and hierarchical HMMs allow for the ability of the system to improve models iteratively over the lifespan of the product. The improvement to the rules may come from a variety of sources. The remote central processing core may leverage its access to large volumes of data, specifically data that has been labeled with ground truth (a notation of what the classification result should be) and improve the classification engine based on large amounts of data. This helps with the baseline capabilities of the system when put into service or as “out-of-the-box”.

Another powerful way that the classification engines may be improved is through user interaction, input or feedback. The system may simply ask the user if the result of the classification was correct and the engine may change the rules it has been using to up-weight or down-weight the result accordingly in what may be characterized as “online semi-supervised learning.” Importantly, the engine may take in disparate sensor data from a number of sources and output statistical probabilities that may then be used to generate an alarm in the case of a security breach event. Because of the use of multiple sensors or sensor nodes and the fusion of this sensor data, the statistical engine may correlate and compute a response to current security conditions. More sensor data, combined with occasionally labeled events, may produce higher fidelity statistical results, strengthen the ability to eliminate false positive reports and strengthen the validity of true positive reports.

As described herein, sensing nodes may be grouped into groupings in individual security systems. These groupings may be of two types: autonomous and user-defined. An example of an autonomously-generated grouping is a grouping of the same types of nodes together in one group.

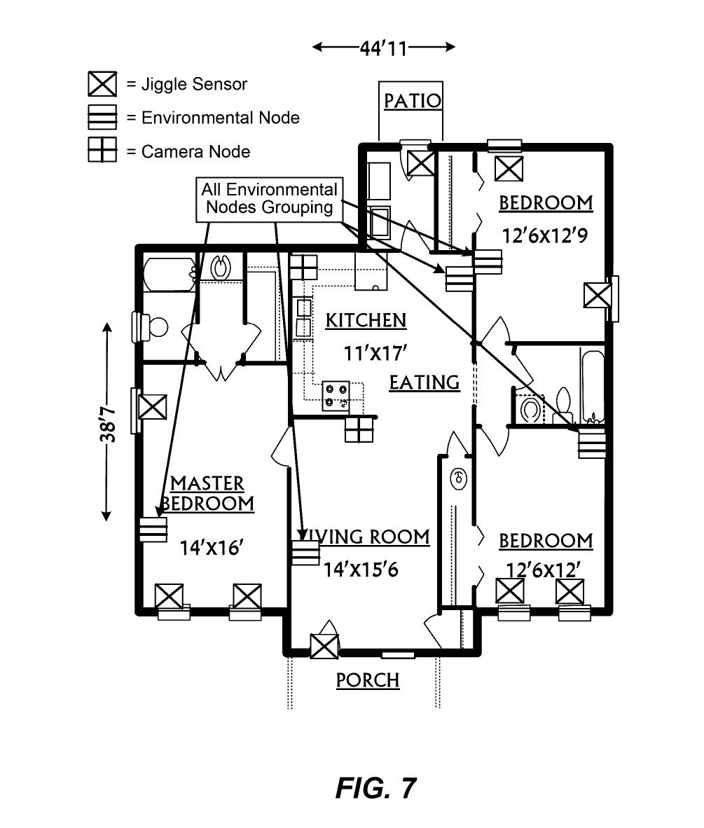

FIG. 7 is an illustration of sensor grouping based on sensor type. A system and classification engine may autonomously group sensors based on sensor type. For example, a sensor may be a window or door sensor that is triggered as a result of the window or door being opened, respectively. Furthermore, a sensor may be a motion detector or a sound detector that detects whether a sound level in an environment exceeded a threshold (for example, as measured in decibels (dB)) or whether a sound having a certain acoustic signature is made, such as a the sound of breaking glass.

The classification engine institutes groupings of different types to detect for specific anomalous activity. If, for example, the rules of the engine specify that the output of sensor type A and sensor type C are correlated to a particular anomaly, the engine may cause the two (or more) types to be coupled into a rule that uses inputs in isolation to improve results. The correlations are often not obvious or intuitive to a human observer and can be quite powerful in application, allowing them to improve the efficacy of the system.

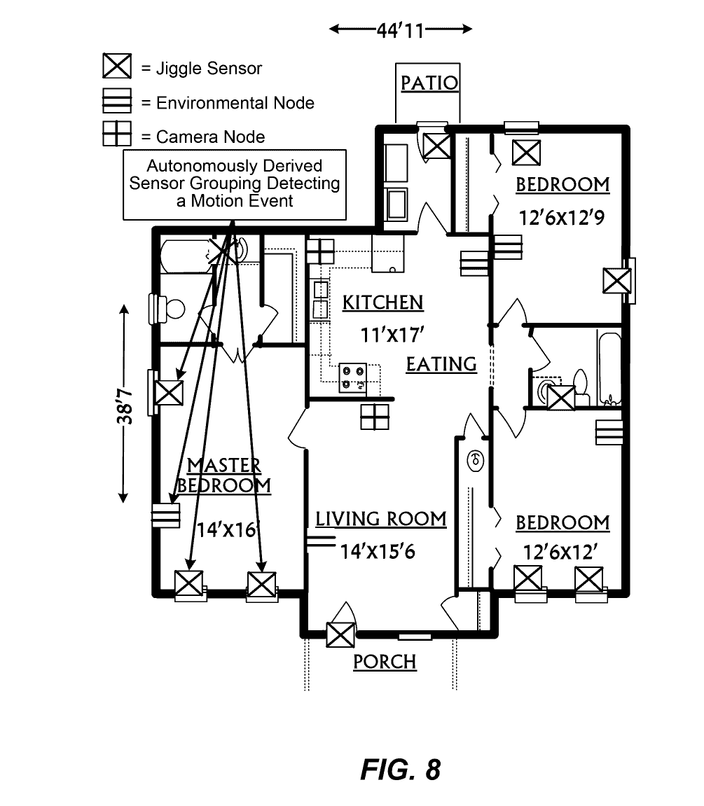

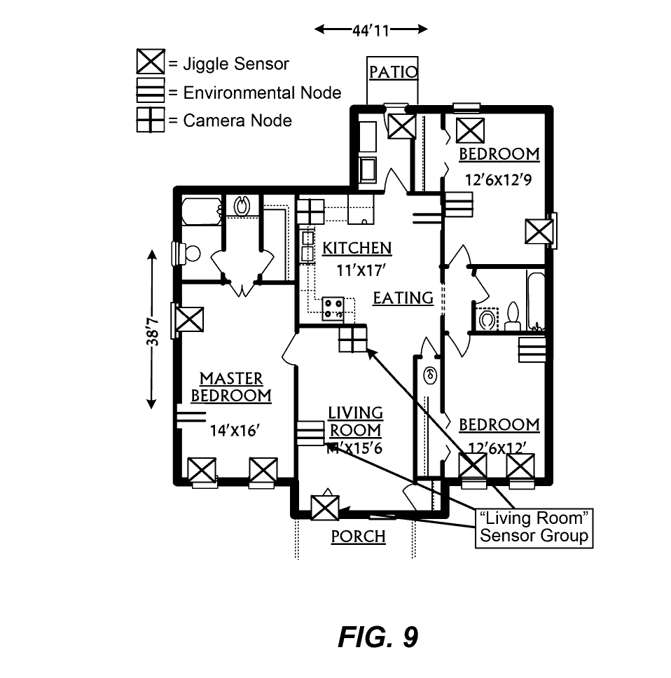

FIG. 8 is an illustration of sensor grouping. The grouping may be autonomously performed, for example, by a classification engine. Further, the grouping may be user-defined. A user may define the grouping based on attributes associated with the sensors or for another reason. For example, it may be difficult for a machine to independently identify that certain sensors pertain to a room of a residence or another structure. For example, the system may be able to detect which sensors are proximally near each other (via radio signal strength, common sensor output, and the like) but it would be difficult to accurately associate these sensors as being in a single room autonomously. However, a human operator may group the sensors in a particular group as shown in FIG. 9 that illustrates user-defined grouping based on location.

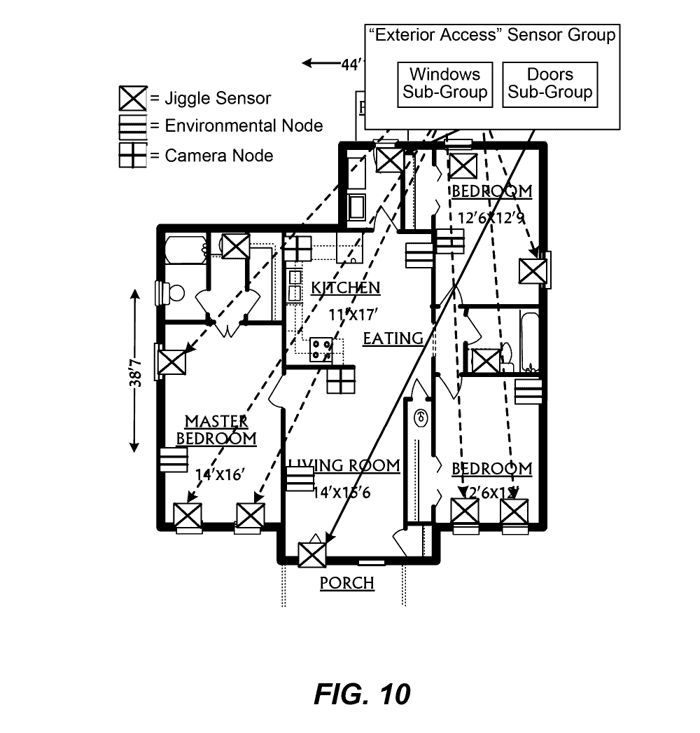

FIG. 10 illustrates an example of sensor grouping based on node attributes. The grouping may be user-defined or autonomously generated. The grouped nodes may, for example, be perimeter nodes that are attached to doors and windows for sensing door or window intrusion. The grouped nodes may all relate to a particular function, such as perimeter security. Also note that this grouping is also comprised of subgroups of window sensors and door sensors.

In light of the sensor grouping examples described herein as well as others contemplated by those skilled in the art, system fidelity may be improved by grouping of data collection sensors. The ability of both the system and the user to identify logical groupings results in improved classification and detection of anomalous behavior. That is due to the fact that the groups of sensors may be mined by the feature extraction methods and the classification engine as configurable sensors themselves.

The security system further permits a user to ascribe actions taken by the system based on specific sensor input. By way of example, consider a door sensor placed on a gun safe. If the user wanted to be alerted every time this particular sensor was activated, such would not be possible if the system was in the unarmed state. By configuring a conditional statement (for example, if-this-then-that), a user can ascribe behavior to a specific sensor and alerting system that is independent of the rules of the classification engine. In this case the user may set a rule that states that any movement of this sensor should send an alert, regardless of the armed state of the system. Another example of this capability is space monitoring, whereby alerts may be sent if the temperature of the wine cellar exceeds a threshold or if the relative humidity in the garage exceeds a certain range (possibly an indication of a plumbing leak.) Providing an interface to the user to create these rules increases the overall value of the whole system.

As described herein, sensors may be grouped in one or more groups and rules specifying one or more criteria for alarm may be provided to a security system. The security system (or a monitoring service thereof) may monitor the sensors and determine whether the one or more criteria are satisfied. Further, the security system may be in communication with the sensors and may receive an indication that one or more of the sensors are triggered. If the at least one of one or more criteria are satisfied, a specified action may be taken. The action may be sending a message to a user or an alarm a security or emergency response center.

A criterion may be temporal or spatial, among others. For example, a criterion may be met if two or more logically grouped sensors are triggered within a specified time period. A sensor may be triggered if movement, a specified sound level or an environmental condition (such as temperature, humidity or pressure) is detected. Sensors may detect environmental conditions in their proximity and may provide an indication of the detected environmental conditions to the monitoring service. An indication of the detected environmental conditions may be a measurement, such as temperature, pressure or sound level. Further, the indication may be a message specifying that a condition is met. For example, the message may specify that a temperature threshold is exceeded or that sound pressure exceeding a specified number of decibels (dB) is detected. In addition, the message may specify that motion is detected.

The monitoring service may evaluate a criterion to determine whether the received indicia of detected environmental conditions satisfy the criterion. A criterion may, for example, be satisfied if a condition placed on a first sensor is met within a specified time period of a condition placed on another sensor being also met. For example, the criterion may be satisfied if the first sensor detects motion within 20 seconds of the second sensor detecting a signature corresponding to broken glass. Due to the criterion being deemed satisfied, the security system may cause a message (for example, text message or phone call) to be sent to a user of the security system.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Many of the methods described herein can be performed with variations. For example, many of the methods may include additional acts, omit some acts, and/or perform acts in a different order than as illustrated or described.

The various embodiments described above can be combined to provide further embodiments. U.S. Provisional Application 62/146,122, filed Apr. 10, 2015 is incorporated herein by reference, in its entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A security system, comprising:
a plurality of sensors of each of at least two different sensor types;
a controller communicatively coupled to the sensors, the controller having at least one processor and at least one nontransitory processor-readable medium communicatively coupled to the controller and which stores at least one of processor executable instructions or data which, when executed by the at least one processor, cause the controller to:
store a set of rules to the at least one nontransitory processor-readable medium, the rules which include at least three rules, the rules different from one another, each of the rules which specify at least one action to take based on a reported sensor condition for a respective set of sensors, at least one of the sets of sensors including at least two of the sensors;
apply the set of rules to the received sensor conditions received from the sensors; and
taking the action specified by a respective one of the rules based on the received sensor conditions.

2. The security system of claim 1 wherein the at least one processor autonomously specifies at least one of the rules based on a history of received sensor conditions.

3. The security system of claim 2 wherein the at least one processor executes a machine learning algorithm to autonomously specify the at least one of the rules based on the history of received sensor conditions and a history of corresponding user input.

4. The security system of claim 2 wherein the at least one processor executes a machine learning algorithm to autonomously specify at least one of new sets of sensors or new rules.

5. The security system of claim 4 wherein the at least one processor prompts a user to accept or reject the new sets of sensors or new rules.

6. The security system of claim 1 wherein the at least one processor receives user input that specifies at least one of the rules of the set of rules.

7. The security system of claim 1 wherein the at least one processor receives user input that specifies at least one of the sets of sensors.

8. The security system of claim 1 wherein the at least one processor receives user input that specifies at least one set of sensor conditions for the sensors of the sets of sensors.

9. The security system of claim 1 wherein the at least one processor receives user input that specifies at least one action to take as part of one of the rules.

10. The security system of claim 1 wherein at least one of the sets of sensors is specified based on a proximity of the sensors with respect to one another.

11. The security system of claim 1 wherein at least one of the sets of sensors is specified based on a sensor type of the sensors.

12. The security system of claim 1 wherein at least one of the sets of sensors is specified based on a room within which the sensors are located.

13. A security system comprising:
a monitoring service that wirelessly communicates with a plurality of sensor nodes, the monitoring service:
receives an indication of a detected environmental condition from a sensor node of the plurality of sensor nodes;
receives data specifying a grouping of a set of sensor nodes of the plurality of sensor nodes and logically groups the set of sensor nodes in response to receiving the data;
receives data specifying one or more conditions for triggering an alarm based on a corresponding set of environmental conditions detected by the set of sensor nodes;
detects that the one or more conditions for triggering the alarm are met; and
sends a message indicating that the one or more conditions for triggering the alarm are met.

14. The security system of claim 13, further comprising:
the plurality of sensor nodes, the sensor node of the plurality of sensor nodes detects the environmental condition in an associated proximity of the sensor node and wirelessly transmits the indication of the detected environmental condition.

15. The security system of claim 13 wherein the data specifying the grouping of the set of sensor nodes and the data specifying the one or more conditions for triggering the alarm are user-specified.

16. A method for providing an alarm, comprising:
receiving, from a sensor of a plurality of sensors, corresponding data indicating an environmental reading of a detected environmental condition in a proximity of the sensor;
receiving one or more criteria for triggering an alarm based on the data corresponding to the plurality of sensors, the one or more criteria for triggering the alarm are satisfied if a first condition placed on a first environmental reading associated with a first sensor of the plurality of sensors is met within a specified time period of a second condition placed on a second environmental reading associated with a second sensor of the plurality of sensors being met;
evaluating the received data corresponding to the plurality of sensors; and
providing the alarm if the one or more criteria for triggering the alarm are satisfied.

17. The method of claim 16 wherein providing the alarm includes sending a message to an address associated with a user of an alarm system.
